(19) United States
(12) Patent Application Publication
(10) Pub. No.: US 2024/0286195 A1
(43) Pub. Date: Aug. 29, 2024

(54) Device And Method For Rapidly Developing Materials For Additive Manufacturing

(71) Applicant: The Johns Hopkins University, Baltimore, MD (US)

(72) Inventors: Robert K. Mueller, Columbia, MD (US); Gianna M. Valentino, Baltimore, MD (US)

(73) Assignee: The Johns Hopkins University, Baltimore, MD (US)

(21) Appl. No.: 18/584,054

(22) Filed: Feb. 22, 2024

Related U.S. Application Data
(60) Provisional application No. 63/486,472, filed on Feb. 23, 2023.

(51) Int. Cl. B22F 10/366; B22F 10/28; B22F 12/30; B33Y 10/00; B33Y 30/00; B33Y 40/10; B33Y 50/02

(52) U.S. Cl. CPC B22F 10/366; B22F 10/28; B22F 12/30; B33Y 10/00; B33Y 30/00; B33Y 40/10

(57) ABSTRACT

A method for rapidly developing additive manufacturing (AM) materials includes disposing a powder layer into a powder pocket of a build device for an AM machine, executing single-line trace patterns with the AM machine on a first portion of the powder layer to form corresponding single-line traces on the build device, and executing sets of multiple-line trace patterns with the AM machine on a second portion of the powder layer to form corresponding sets of multiple-line traces on the build device.

### CROSS-REFERENCE TO RELATED APPLICATION

This application claims priority to and the benefit of prior-filed, co-pending U.S. Provisional Application Ser. No. 63/486,472, filed on Feb. 23, 2023, the entire content of which is herein incorporated by reference.

### TECHNICAL FIELD

Example embodiments relate generally to powder-based additive manufacturing, and more particularly, relate to methods, systems, and devices that allow for the rapid development and screening of both materials and processing parameters for use in metal additive manufacturing.

### BACKGROUND

Additive manufacturing, sometimes referred to as 3D printing, is a process used to create objects by sequentially layering or stacking materials, based on a computer aided design (CAD) or other digital model. Additive manufacturing is in contrast to subtractive manufacturing, where materials are removed (e.g., machined) from a larger piece of the material to create an object.

There are a number of different types of additive manufacturing, including polymerization, material jetting, extrusion, lamination, and material fusion. One particular type of material fusion, known as powder bed fusion, uses the energy from a laser, electron beam, or other directed source of energy to sinter or melt together portions of a powder that is layered onto a build platform. As additional layers of the powder are added, and subsequently melted together by an energy source, on top of the previously-added layers, the desired object is formed.

Current laser-powder bed fusion (L-PBF) additive manufacturing (AM) entails a complicated, costly, and time-consuming up-front process to develop, test, and screen new materials and laser processing parameters for manufacturing a particular object. For example, different types of materials (or combinations of materials) must be developed and created, and the manufacturing parameters (laser power, speed, hatch spacing, and powder layer thickness, etc.) must be optimized to produce an acceptable end product. This process is iterative, with different combinations of materials and manufacturing parameters being tested until an acceptable combination is developed. This results in the use of substantial amounts of powder, as several kilograms of powder (or more) must be loaded into the AM machine's hopper. Additionally, the iterative nature of these processes requires expending a significant amount of time and effort before optimal materials and manufacturing parameters can be determined and manufacture of the desired object can begin.

Accordingly, there is an ongoing need for improved methods, devices, and systems for rapidly developing, testing, and screening materials, and the optimal parameters associated with their use in additive manufacturing, including for L-PBF AM.

### BRIEF SUMMARY

According to some non-limiting, example embodiments, a method for rapidly developing additive manufacturing materials includes disposing a powder layer into a powder pocket of a build apparatus/device for an additive manufacturing (AM) machine, executing a plurality of single-line trace patterns with the AM machine on a first portion of the powder layer to form a corresponding plurality of single-line traces on the build apparatus/device, and executing a plurality of sets of multiple-line trace patterns with the AM machine on a second portion of the powder layer to form a corresponding plurality of sets of multiple-line traces on the build apparatus/device.

According to other non-limiting, example embodiments, a method for rapidly developing additive manufacturing materials consists of disposing a powder layer into a powder pocket of a build apparatus/device for an AM machine, executing a plurality of single-line trace patterns with the AM machine on a first portion of the powder layer to form a corresponding plurality of single-line traces on the build apparatus/device, and executing a plurality of sets of multiple-line trace patterns with the AM machine on a second portion of the powder layer to form a corresponding plurality of sets of multiple-line traces on the build apparatus/device. No powder is loaded into the powder hopper of the AM machine.

According to yet other non-limiting, example embodiments, a build apparatus/device for an AM process includes a base a powder pocket formed in an upper portion of the base to receive a single powder layer.

According to additional non-limiting, example embodiments, a system for rapidly developing AM materials includes a build apparatus/device and a plate configured to receive the build apparatus/device. The build apparatus/device includes a base and a powder pocket formed in an upper portion of the base to receive a single powder layer.

### BRIEF DESCRIPTION OF THE SEVERAL VIEWS OF THE DRAWINGS

The above and other aspects, features, and advantages will become more readily apparent from the detailed description, accompanied by the drawings, in which:

FIG. 1 illustrates a build device for an additive manufacturing (AM) process according to some example embodiments;

FIG. 2 illustrates a powder layer deposited in a powder pocket of a build device according to some example embodiments;

FIG. 3 illustrates a modified reduced AM build plate within a modified full AM build plate according to some example embodiments;

FIG. 4 is a closeup view of the modified reduced build plate shown in FIG. 3, illustrating a recess for receiving a build device according to some example embodiments;

FIG. 5 illustrates a bottom portion of the modified reduced build plate shown in FIG. 4 according to some example embodiments;

FIG. 6 illustrates a build device in a modified reduced build plate according to some example embodiments;

FIG. 7 illustrates a modified reduced build plate according to some alternative example embodiments;

FIG. 8 illustrates programmed trace patterns for an AM process according to some example embodiments;

FIG. 9 illustrates executed laser patterns from an AM process according to some example embodiments;

FIG. 10 is a cross-sectional microscopy image of a single-line trace from an AM process according to some example embodiments;

FIG. 11 is a cross-sectional microscopy image of a multiple-line trace from an AM process according to some example embodiments; and

FIG. 12 illustrates an example method of rapidly developing AM materials according to some example embodiments.

### DETAILED DESCRIPTION

Some non-limiting, example embodiments will now be more fully described with reference to the accompanying drawings, in which some, but not all example embodiments are shown. Indeed, the examples described, shown, and illustrated herein should not be construed as being limiting as to the scope, breadth, applicability, or configuration of this disclosure. Rather, these example embodiments are provided so that this disclosure will satisfy applicable legal requirements. Like reference numerals refer to like elements throughout. Furthermore, as used herein, the term “or” is to be interpreted as a logical operator that results in a true output whenever one or more of its operands are true. Additionally, as used herein, operable coupling should be understood to relate to direct or indirect connection that, in either case, enables functional, but not always physical, interconnection of components that are described as being operably coupled to each other.

The non-limiting, example embodiments, including various apparatuses, systems, and methods shown and described herein, enable the ability to rapidly develop, test, screen, and use materials, and the optimal parameters associated with their use, in additive manufacturing (AM) processes. In particular, various apparatuses, systems, and methods for laser-powder bed fusion (L-PBF) AM will be described herein, but it will be understood that alternative example embodiments are not limited to L-PBF AM. Rather, the embodiments described herein may be used in many different types of AM, including other (non-laser) powder bed and/or directed energy-type AM processes, such as electron beam melting (EBM), selective heat sintering (SHS), plasma/electric arc methods, and binder jet fusion, for example. In addition, various powder-bed laser methods may be used in the processes particularly described herein (L-PBF), including direct metal laser sintering (DMLS), selective laser sintering (SLS), and selective laser melting (SLM), for example, although additional or alternative example embodiments are not limited thereto.

Regardless of the particular application, the various apparatuses, systems, and methods described herein allow for significantly enhanced, rapid development, testing, and screening of potential materials for use in the AM process involved, as well for quickly and efficiently determining the optimal manufacturing parameters associated with their use in AM. Specifically, and for purposes of brevity referring hereinafter to example embodiments particularly associated with L-PBF (though it will be understood that alternative embodiments are not limited thereto), various materials (or combinations of materials) can be rapidly tested, using a standard L-PBF AM machine and the example embodiments described herein, to determine the material's suitability for use in a full- or large-scale AM process. More specifically, samples of various materials can be created by the AM machine without the need to fill the machine's powder hopper, resulting in an orders-of-magnitude decrease in the amount of powder needed for testing using conventional apparatuses, systems, and methods.

Moreover, multiple combinations of laser processing parameters used in the creation of the materials (laser power, scan speed, scanning strategy/angle, hatch spacing/distance, layer thickness, etc.) can be quickly and efficiently evaluated for optimization. If desired, other parameters, such as environmental (temperature, pressure, oxygen level, etc.) and/or material (powder melt temperature, build plate compatibility, and conductivity, etc.), can be manipulated and quickly tested to dramatically decrease the time and amount of powder needed to optimize the overall process and material used in the subsequent full-scale production of a given object or part manufactured using L-PBF.

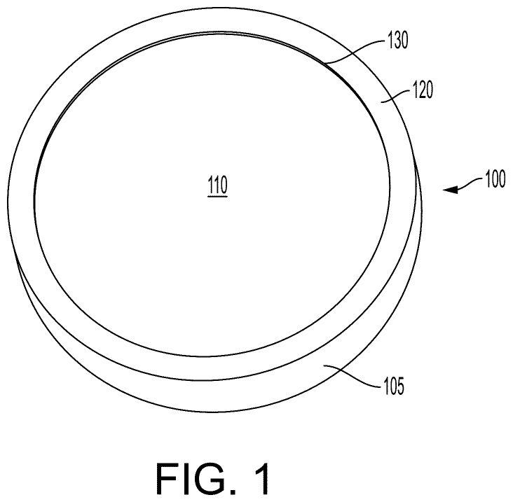

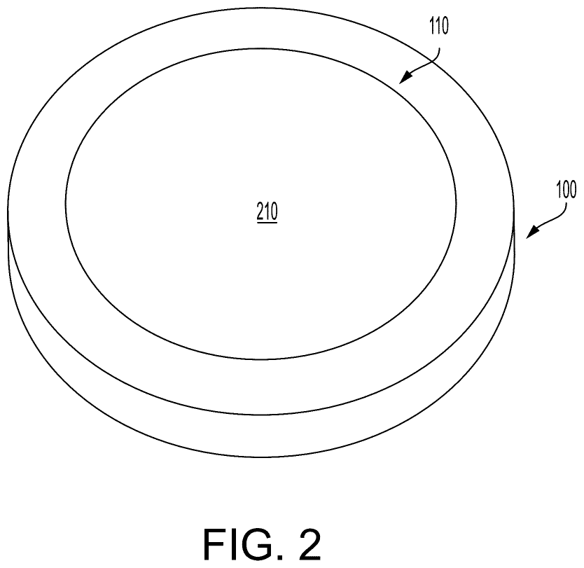

Having thus described some concepts and features of various example embodiments, reference is now made to FIGS. 1 and 2, which illustrate a build apparatus or device for an L-PBF AM process. As shown in FIG. 1, a build apparatus or device 100 according to various example embodiments includes a base 105, which can be any suitable type of feedstock (e.g., metal or metal alloy). A powder pocket 110 is milled or otherwise formed in an upper surface 120 of the base 105 of the build apparatus or device 100. The powder pocket 110 has an outer periphery/circumference 130 that is less than the circumference of the upper surface 120 of the base 105/build apparatus or device 100.

While the build apparatus or device 100 in the example embodiment shown FIG. 1 is a disk (e.g., a circular plate or object), it will be understood that the build apparatus or device 100 according to alternative example embodiments need not necessarily be circular in shape. Rather, the build apparatus or device 100 may be in other shapes or configurations, such as ovals, squares, rectangles, triangles and other polygons, etc., depending upon the particular L-PBF process, machine, or materials in a particular circumstance. Thus, while the build apparatus or device 100 shown and described herein will be referred to as a “disk” (i.e., “the build disk 100”), the use of that particular term is not intended to limit the build disk 100 to any particular shape in alternative example embodiments.

The build disk 100 according to various example embodiments is made from any suitable feedstock (e.g., a piece of metal or metal alloy). In one example embodiment, the build disk 100 may be a 1-inch diameter metal disk, with the powder pocket 110 being machine-milled into one surface (e.g., the upper surface 120, as viewed in FIG. 1) of the metal disk. The depth of the powder pocket 110 (relative to the upper surface 120) is completely customizable, to allow for testing and experimentation to determine the optimal powder bed layer thickness effect for a particular L-PBF process and, in particular for a given powder size distribution, for example. In example embodiments associated with L-PBF AM processes, a depth of the powder pocket 110 may be on the order of from several micrometers to several dozen μm or more. In one example embodiment, the depth may be from about 20 μm to about 50 μm. In another example embodiment, the depth may be from about 30 μm to about 40 μm (or, in yet another example embodiment, an even a smaller range in between). However, in alternative example embodiments, or for different types of AM processes, the depth may be different.

As shown in FIG. 2, the configuration of the build disk 100 according to various example embodiments allows for the placement of a powder layer 210 in the powder pocket 110 of the build disk 100. The ability to place the powder layer 210 directly in the powder pocket 110 of the build disk 100 allows for only a very small amount of powder to be processed in an L-PBF AM machine. In addition, the recessed shape (e.g., the depth) of the powder pocket 110 allows powder to be placed (e.g., sprinkled) in the middle of the powder pocket 110, after which any straight-edged device (e.g., a knife, razor blade, AM machine's recoater, etc.) can be used to smooth, flatten, and evenly distribute the powder layer 210 in the powder pocket 200. This recessed pocket design of the powder pocket 110 according to example embodiments allows for maintaining a uniform powder bed layer thickness, defined by how deep the powder pocket 110 has been milled into the build disk 100, which is particularly important in powder-based AM processes.

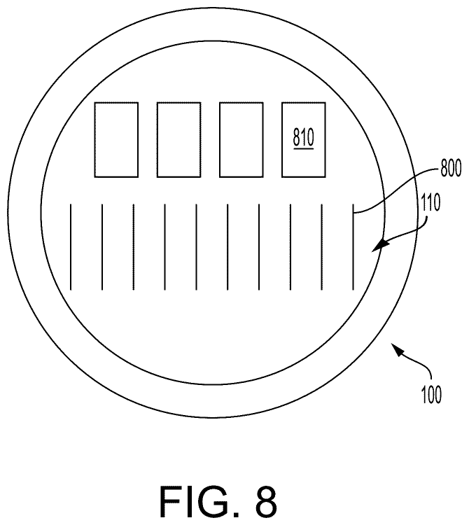

Additionally, the build disk 100 according to example embodiments completely eliminates the need for any powder to be loaded into the AM machine's hopper. This makes it possible to rapidly test and develop various materials and parameters related to the L-PBF process simultaneously, resulting in substantial increases in the overall efficiency of those process, along with a substantial reduction in materials (e.g., powder) required for those processes, as will be described in greater detail below with reference to FIGS. 8-12.

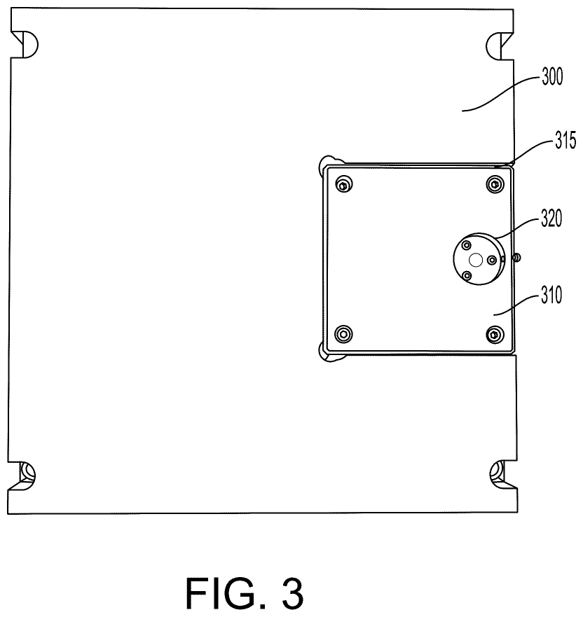

To use the build disk 100 in an L-PBF AM machine, the build disk 100 must be accurately and securely placed on the build plate or platform, sometimes generally referred to as the “powder bed” area of the machine where, during normal, at-scale operation, a layer of powder is alternately and repeatedly spread across the platform and then processed (e.g., melted or sintered) by the laser to create an object layer by layer. Accordingly, in various example embodiments, standard L-PBF build plates are modified to accommodate the build disk 100, as will now be described with reference to FIGS. 3-7.

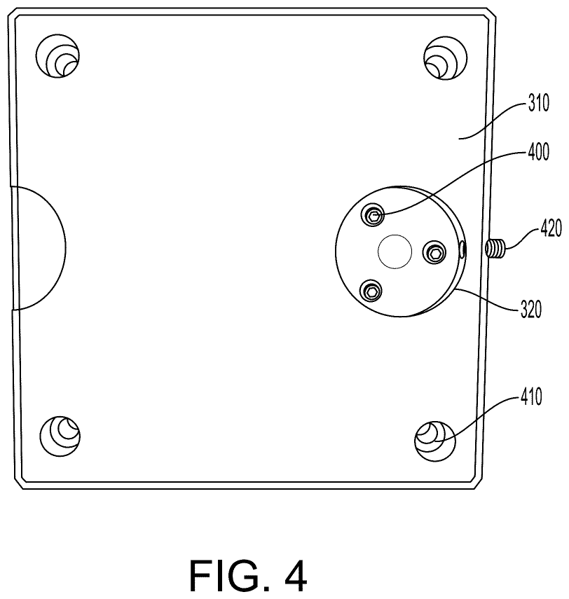

FIG. 3 illustrates a modified reduced build plate within a modified full build plate according to some example embodiments, and FIG. 4 is a closeup view of the modified reduced build plate shown in FIG. 3, illustrating a recess for receiving the build disk 100 according to various example embodiments.

In the L-PBF AM process, large, or full, build plates and small, or reduced, build plates are essentially rectangular- or square-shaped pieces of metal upon which powder may be alternately layered and treated with a laser to build an object. As can be seen in FIGS. 3 and 4, example embodiments include a larger, modified full build plate 300, and a smaller, modified reduced build plate 310 disposed within the modified full build plate 300. According to an example embodiment shown in FIG. 3, the modified full build plate 300 is modified to accommodate the square-shaped modified reduced build plate 310, and the modified reduced build plate 310 is modified to accommodate the circular build disk 100 (shown in FIGS. 1 and 2). Specifically, a square (or rectangular) recess 315 may be milled into (or fully out of) a portion of the modified full build plate 300 to receive the modified reduced build plate 310, while a circular recess 320 may be milled into (or fully out of) a portion of the modified reduced build plate 310 to receive the build disk 100. It will be understood that, as described above, when the build disk 100 according to alternative example embodiments is in an other-than-circular form, the corresponding recess 320 will conform to that alternative form. Similarly, when the shapes of the full and/or reduced build plates are other than square or rectangular, the modifications (e.g., recesses) made to these differently-shaped build plates will be adjusted accordingly.

A bottom portion of the recess 320 (as viewed in FIG. 4) includes leveling screws 400 (three leveling screws 400 are shown in FIG. 4, but alternative example embodiments are neither required nor limited thereto). The leveling screws 400 can be individually adjusted to ensure that the build disk 100 is level in the recess 320 within the modified reduced build plate 310, e.g., that the upper surface of the modified reduced build plate 310 is flush with the upper surface 120 of the build disk 100 (FIG. 1). Four mounting screws 410 secure the modified reduced build plate 310 to the modified full build plate 300.

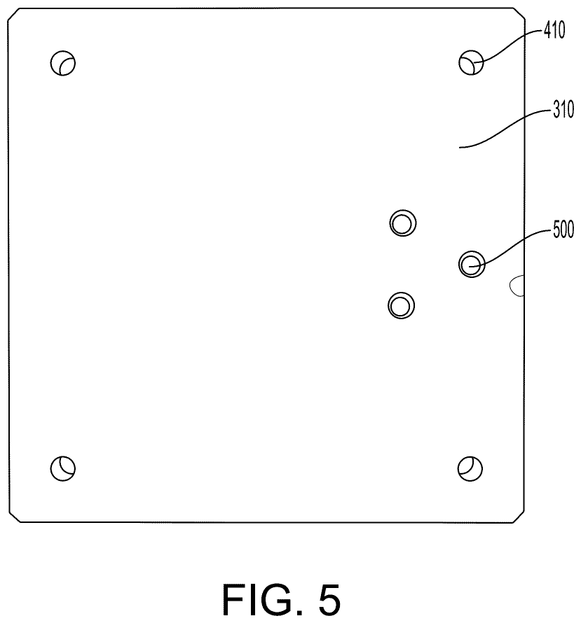

As shown in FIG. 5, which illustrates a bottom portion of the modified reduced build plate 310 shown in FIG. 4, levelling screw holes 500 penetrate fully through the modified reduced build plate 310 within the recess 320 (FIG. 4) to allow alignment (leveling) of the build disk 100 within the modified reduced build plate 310 as the leveling screws 400 as the screws are moved up and down to press against the bottom portion of the recess 320 in varying degrees (e.g., heights). Once the build disk 100 is leveled within the recess 320, it is secured to the modified reduced build plate 310 with a side set screw 420 (FIG. 4).

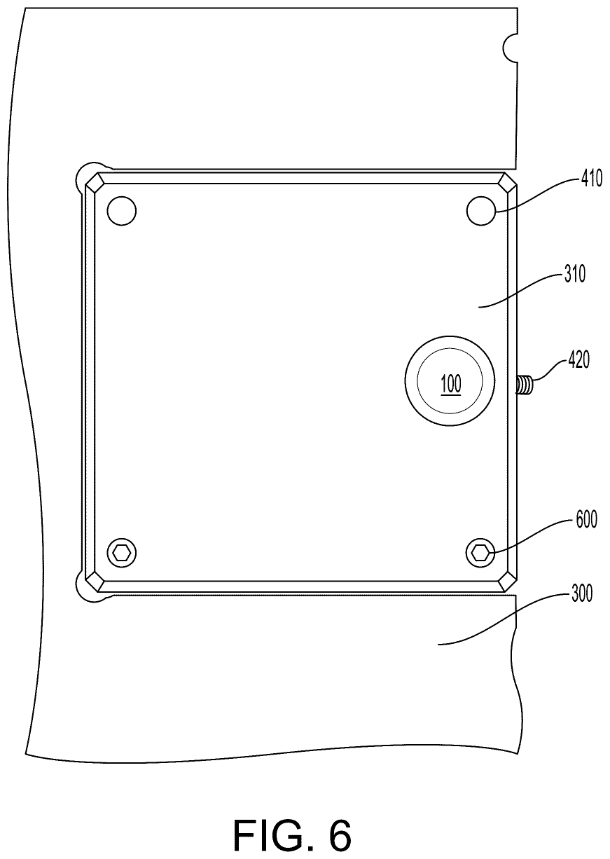

FIG. 6 illustrates the build disk 100 levelled and mounted in the modified reduced build plate 310 according to various example embodiments. The build disk 100 and modified reduced built plate 310, as configured in FIG. 6, are ready to be placed in the L-PBF AM machine for use as will be described in greater detail below with reference to FIGS. 8-12.

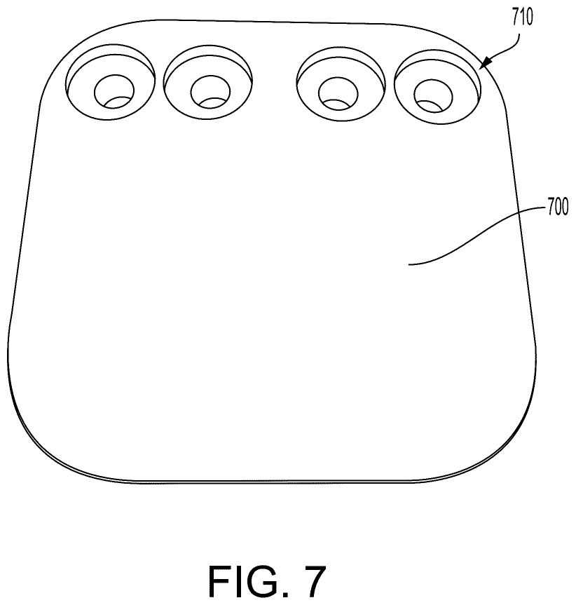

FIG. 7 illustrates a modified reduced build plate according to some alternative example embodiments. As can be seen in FIG. 7, a modified reduced build plate 700 according to an example embodiment includes recesses 710 that may be smaller than the recess 320 in the modified reduced build plate 310 depicted in FIG. 3. Specifically, in the example embodiment shown in FIG. 7, the recesses 710 are each about 0.5 inches in diameter (although alternative example embodiments are not limited thereto), resulting in the modified reduced build plate 700 having four of the recesses 710, allowing for a corresponding four build disks (e.g., four of the build disks 100 shown in FIG. 1) to be used at one time. This even further increases the efficiency, including the time and material savings discussed above, in the overall L-PBF AM process. Though not shown in FIG. 7, set/mounting and/or leveling screws may be included in the modified reduced build plate 700, similar as shown and described above with reference to FIG. 4, though such screws are not necessarily required in some example embodiments of the modified reduced build plate 700.

As mentioned above, the pre-production process for L-PBF AM includes determining the best materials (e.g., type of powder), as well as the optimal processing parameters for the production (at-scale) manufacturing a given object or part. For example, laser power, scan speed, scanning strategy/angle, hatch spacing/distance, and layer thickness, must all be evaluated and optimized for the material (or materials) selected for the AM process. Traditionally, this iterative process has required multiple developmental trials, or “test runs,” where several kilograms of given material (powder) are loaded into the powder hopper of the L-PBF machine and a sample part or component is then printed and individually evaluated. In the next iteration, the entire system needs to be fully cleaned out, then several kilograms of a different material (powder) and/or different processing parameters are used in another developmental trial to print another sample part, which is then individually evaluated. This process must be repeated until the optimal material and processing parameters are determined, which requires a substantial amount of time and materials. In contrast, in various example embodiments, a significantly smaller amount of material (powder), e.g., only a few grams, is needed and used to conduct multiple developmental trials in a single print cycle of the AM machine. Additionally, this can be done using multiple materials (powder) and/or processing parameters, simultaneously, because there is no need to using the AM machine's hopper. As a result, in example embodiments, multiple samples are produced, and can all be evaluated after the single print cycle, as will now be described in further detail with reference to FIGS. 8-12.

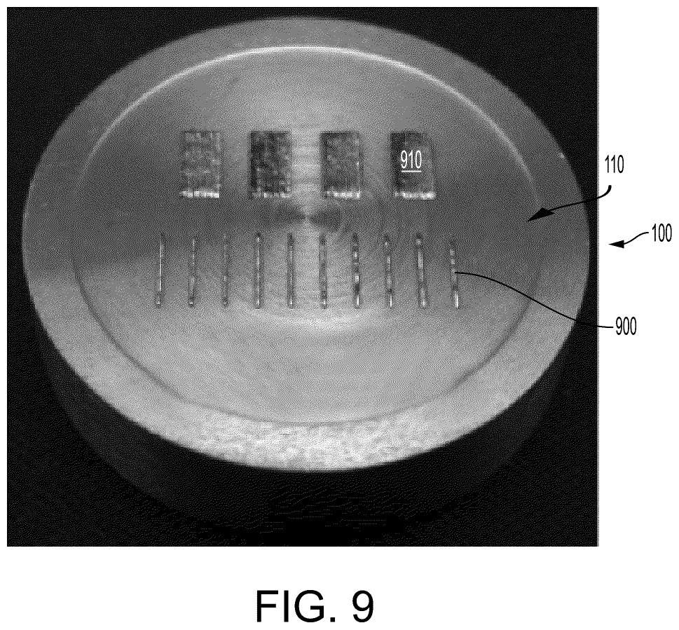

FIG. 8 illustrates programmed laser trace patterns for an L-PBF process according to some example embodiments, and FIG. 9 illustrates executed laser traces, i.e. solidified materials, according to the patterns shown in FIG. 8. Specifically, FIG. 8 shows multiple developmental trials (mentioned above), which the L-PBF machine uses to create multiple material samples for evaluation with different processing conditions. More specifically, for a given developmental trial, the L-PBF machine can be programmed to execute one or more single-line trace patterns 800, as well as one or more multiple-line (“hatched” or “grid”) trace patterns 810 in the powder pocket 110 area on the build disk 100 according to various example embodiments.

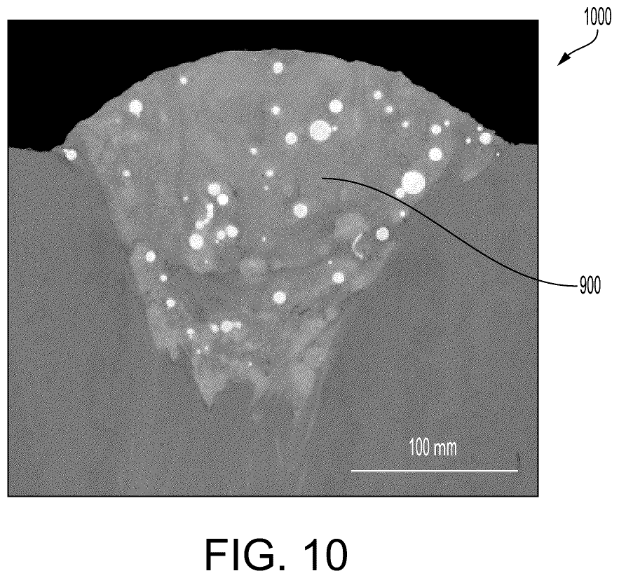

As shown in FIG. 8, each of the single-line trace patterns 800 corresponds to an individual, single laser pass, resulting in a thin, single trace of metal when the powder on the build disk 100 is treated with the laser. This results in a stand-alone trace, i.e. a single-line trace 900 (FIG. 9) that does not interact with or touch any other traces, as can also be seen in FIG. 10 (discussed below). Though ten single-line trace patterns 800 are shown in the example embodiment of FIG. 8, and hence ten single-line traces 900 (FIG. 9), alternative example embodiments are not limited thereto, and may contain more or less single-line traces, depending on the size of the particular build disk 100, as well as the arrangement of the other traces on the build disk 100.

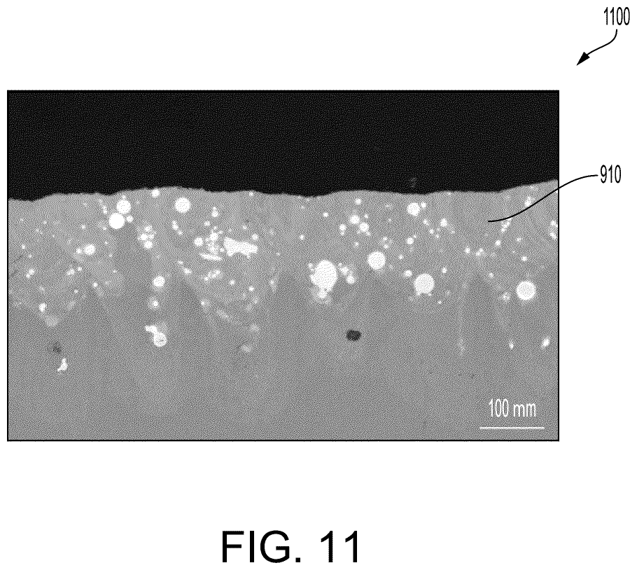

Still referring to FIG. 8, four sets of multiple-line trace patterns 810 can be seen, located above the single-line trace patterns 800 on the build disk 100. Each set of multiple-line trace pattern 810 results in a series of adjacent (hatched) traces, e.g., multiple side-by-side single-line traces touching each other to form a set of multiple-line (hatched) traces 910 (FIG. 9), with each individual trace within a given set touching its adjacent traces in the hatched pattern. This can be more clearly seen in FIG. 11, which will be discussed in more detail below. Though four multiple-line trace patterns 810 are shown in the example embodiment of FIG. 8, resulting in four sets of multiple-line (hatched) traces 910 (FIG. 9), alternative example embodiments are not limited thereto, and may contain more or less sets of multiple-line traces 910, depending on the size of the particular build disk 100, as well as the arrangement of the other traces on the build disk 100.

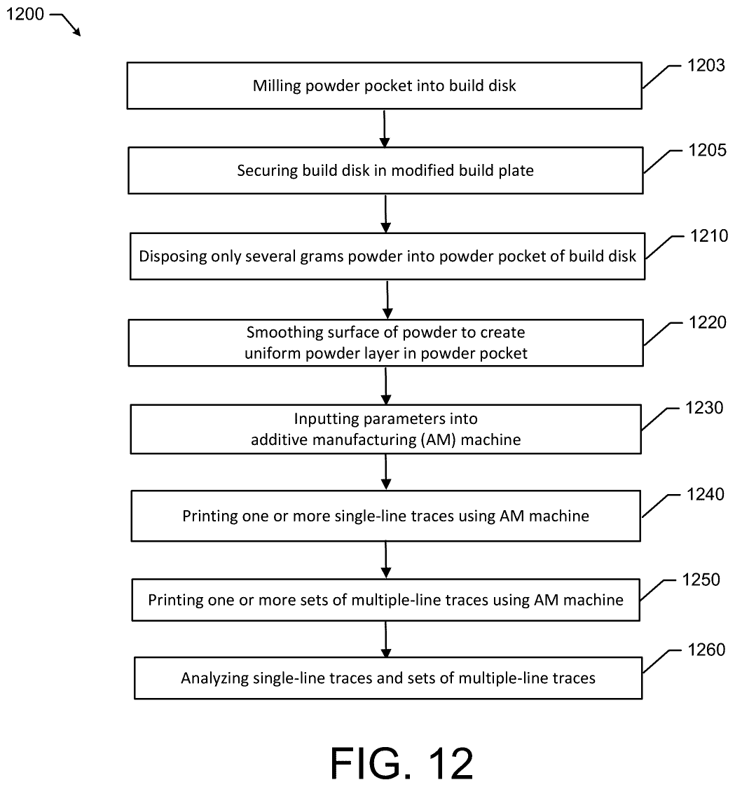

As mentioned above, in example embodiments, each single L-PBF developmental trial conducted on a given build disk 100 provides, for a particular powder placed in the powder pocket 110, multiple sample traces (a total of 14, in the example embodiment shown in FIGS. 8 and 9, i.e. ten single-line traces 900 and four sets of multiple-line traces 910). Different processing/laser parameters can be set for each of the 14 traces (or sets of traces), and the traces/sets of traces can all be examined to determine the suitability of the corresponding material and associated processing parameters used to create the trace/set or traces. This greatly increases the efficiency of the pre-production, or test phase of the L-PBF AM process, saving substantial time by reducing the number of individual developmental trial (e.g., “test runs”) that must be conducted, as well as by significantly reducing the amount of powder required for each run, since the powder is loaded directly onto the build disk 100 (as will be described in greater detail below with reference to FIG. 12), completely eliminating the need to load any powder into the powder hopper of the L-PBF machine. Specifically, in example embodiments, only a very small amount of powder, e.g., several grams, is needed to conduct a developmental trial (in contrast, a conventional L-PBF machine requires several kilograms of powder to be loaded into the machine hopper for each developmental trial). In one example embodiment, for example, less than about 50 grams of powder is needed and, in another example embodiment, less than 10 grams of powder is needed. It will be understood that alternative example embodiments will not be limited to the foregoing powder quantities; rather, the amount of powder needed for a developmental trial using example embodiments will depend, among other things, on the density of the metal or metal alloy used in the powder (tungsten, for example, is denser than aluminum, for example, and thus less tungsten, weight-wise, may be required than the required weight of an equivalent amount of aluminum, etc.). However, developmental trials using example embodiments will always require substantially less powder than required for trials using a conventional AM machine (which requires kilograms of powder, as discussed above).

In addition to substantially reducing (by orders of magnitude) the amount of powder needed for a given developmental trial, example embodiments provide additional, significant advantages. For example, using the modified reduced build plate 700 shown in FIG. 7, multiple pocketed build disks 100 are loaded into the AM system with different powders in each build disk 100, whereas traditional L-PBF systems only allow for the exploration of one material at a time (i.e. one material per development run). Accordingly, in example embodiments, one developmental trial allows for multiple tests, dramatically increasing processing design space and throughput.

Referring now to FIG. 9, once a given developmental trial has been run, resulting in the single-line traces 900 and the sets of multiple-line traces 910, each trace or set of traces can then be investigated in a number of ways, including but not limited to, visual inspection, microscopy, and/or cross-sectional microscopy (described below with reference to FIGS. 10 and 11), to investigate the solidified (printed) material. This allows for evaluation and comparison of various parameters, such as melt pool widths and depths, to determine which powder materials, build plate materials, and laser processing parameters would be most successful in scaling up to the production of a full-scale, 3-dimensional (3D) structure or object.

FIG. 10 is a cross-sectional microscopy image 1000 of one of the single-line traces 900 and FIG. 11 is a cross-sectional microscopy image 1100 of a portion of one of the sets of multiple-line traces 910 according to some example embodiments. As can be seen in FIG. 10, the single-line trace 900 results from a single laser pass, yielding a single, stand-alone trace of metal. Among the other evaluation/investigation methods mentioned above, the cross-sectional microscopy image 1000 is helpful in determining, among other things, the dimensions (height, width, depth) of individual melt pools (e.g., weld lines), internal defects, such as pores and/or cracks, and unmelted powder within the single line trace 900, providing valuable feedback in the process of determining the best material(s) and processing parameters for use in manufacturing the full-size, 3D model.

Similarly, the cross-sectional microscopy image 1100 of the portion of one of the sets of multiple-line traces 910 (FIG. 11) is helpful for evaluating, among other things, different hatch spacings (the amount of overlap between adjacent laser passes) to determine the optimal overlap distance to minimize porosity during a full-scale build. Specifically, in one example embodiment, each one of the four sets of multiple-line traces 910 (FIG. 9) is printed using a different hatch spacing from the other three sets of multiple-line traces 910 to help determine the optimal hatch spacing for a given L-PBF AM process. In addition, these evaluations, described in greater below with reference to FIG. 12, can easily be repeated with different types of material, specifically, both different powder material, and/or material (e.g., feedstock) used for the build disk (as described above with reference to FIGS. 1 and 2), and/or with different hatch spacings or other laser parameters, by simply repeating the process with another build disk 100, which can be done without placing the different powder in the L-PBF machine hopper, significantly reducing the amount of powder needed to carry out these developmental trials.

Now referring to FIG. 12, an example method 1200 for rapidly developing L-PBF AM materials will be described in further detail. According to various example embodiments, the example method 1200 may include, at 1203, milling the powder pocket 110 into the upper surface 120 of the base 105 of the build disk 100, as described in greater detail above with reference to FIGS. 1 and 2. At 1205, the build disk 100, having the powder pocket 110 milled therein, is secured within the modified reduced build plate 310 and/or the modified full build plate 300, as described in greater detail above with reference to FIGS. 3-7.

According to various example embodiments, the example method 1200 may further include, at 1210, placing/disposing, e.g., sprinkling or pouring, power into the powder pocket 110 of the build disk 100 and, at 1220, smoothing the powder in the powder pocket 110 to produce a flat, uniform and evenly distributed powder layer 210, as described in greater detail above with reference to FIG. 2. In example embodiments, only a small quantity, e.g., several grams, of powder is in the powder layer 210, such as from only about 5 grams to only about 50 grams of powder and, in an example embodiment, less than about 10 grams of powder may be used in the powder layer 210, although alternative example embodiments are not limited to the foregoing powder quantities, as discussed in greater above with reference to FIGS. 8 and 9. The powder may be any material suitable for the associated powder-based AM process (L-PBF being one specific example described herein), such as metal. No powder is put in the AM machine's hopper.

At 1230, various L-PBF processing parameters (laser power, scan speed, scanning strategy/angle, hatch spacing/distance, layer thickness, etc.) are inputted into the AM machine.

At 1240, a number of single-line traces 900 (FIGS. 9 and 10) are created using the AM machine.

At 1250, a number of sets of multiple-line traces 910 (FIGS. 9 and 11) are created using the AM machine.

At 1260, the single-line traces 900 and the sets of multiple-line traces 910 are analyzed, as described above with reference to FIGS. 10 and 11).

Though not shown specifically in FIG. 12, alternative example embodiments may include additional steps, such as mounting, securing, and/or levelling the build disk 100 into the modified reduced build plate 310, as described above with reference to FIGS. 3-6, as well as argon/nitrogen purging for an inert atmosphere and brushing away unmelted powder from the build disk 100 after the traces in steps 1240 and/or 1250, etc.

As mentioned above, in various example embodiments, the method 1200 (and/or the individual steps thereof) can easily be repeated, with minimal powder use, until the optimum material and L-PBF AM process parameters for a particular full-scale (3D) build have been determined, resulting in substantial efficiencies in time, effort, and material for the overall AM process.

According to some example embodiments, a method for rapidly developing additive manufacturing (AM) materials includes disposing a powder layer into a powder pocket of a build device for an AM machine, executing a plurality of single-line trace patterns with the AM machine on a first portion of the powder layer to form a corresponding plurality of single-line traces on the build device, and executing a plurality of sets of multiple-line trace patterns with the AM machine on a second portion of the powder layer to form a corresponding plurality of sets of multiple-line traces on the build device. The build device may be a build disk. A total amount of powder in the powder layer may be less than about 50 grams. A depth of the powder pocket within an upper surface of the build device may be from about 20 micrometers (μm) to about 50 μm. The method may further include milling the powder pocket into the build device, and securing the build device into at least one of a modified full build plate of the AM machine and a modified reduced build plate of the AM machine. The method may further include smoothing a surface of the powder layer in the powder pocket. The method may further include inputting one or more processing parameters into the AM machine. The one or more processing parameters inputted into the AM machine may include laser power, scan speed, scanning strategy, scanning angle, hatch spacing, hatch distance, and layer thickness. The method may further include analyzing single-line traces of the plurality of single-line traces and sets of multiple-line traces of the plurality of multiple-line traces. The analyzing the single-line traces and the sets of multiple-line traces may include performing visual inspection, microscopy, and/or cross-sectional microscopy. The AM machine may be a laser-powder bed fusion (L-PBF) AM machine.

According to some example embodiments, a method for rapidly developing AM materials consists of disposing a powder layer into a powder pocket of a build device for an AM machine, executing a plurality of single-line trace patterns with the AM machine on a first portion of the powder layer to form a corresponding plurality of single-line traces on the build device, and executing a plurality of sets of multiple-line trace patterns with the AM machine on a second portion of the powder layer to form a corresponding plurality of sets of multiple-line traces on the build device. The method may further consist of smoothing a surface of the powder layer in the powder pocket, and inputting one or more processing parameters into the AM machine. The method may further consist of analyzing single-line traces of the plurality of single-line traces and sets of multiple-line traces of the plurality of multiple-line traces. The AM machine may be an L-PBF AM machine. A total amount of powder in the powder layer may be less than about 50 grams.

According to some example embodiments, a build device for an AM process includes a base and a powder pocket formed in an upper portion of the base to receive a single powder layer. A depth of the powder pocket may be from about 20 μm to about 50 μm, and the powder pocket may be formed to contain a total amount of powder that is less than about 50 grams. The base may be a disk having a circular shape, and an outer circumference of the powder pocket may be circular and less than an outer circumference of the disk.

According to some example embodiments, a system for rapidly developing AM materials includes a build device and a plate configured to receive the build device. The build device may include a base and a powder pocket formed in an upper portion of the base to receive a single powder layer. A depth of the powder pocket may be from about 20 μm to about 50 μm, and the powder pocket may be formed to contain a total amount of powder that is less than about 50 grams. The build device may be a build disk having a circular shape, and an outer circumference of the powder pocket may be circular and less than an outer circumference of the build disk. The plate may be a modified build plate an L-PBF AM machine.

It will be understood that other ways, means, and/or components of implementing the example embodiments shown and described herein are also contemplated, including, but not limited to, different sizes, shapes, areas, volumes, and geometries of the various apparatuses/devices, plates, and pockets, as well as the manner in which (and amount of) powder is disposed into the powder pocket, the powder is smoothed, parameters are inputted into the AM machine, as well as the manner in which single- and multiple-line traces are printed and/or analyzed.

Many other modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the spirit or scope of the appended claims. In this regard, for example, different combinations of elements and/or functions than those explicitly described above are also contemplated as may be set forth in some of the appended claims. In cases where advantages, benefits, or solutions to problems are described herein, it will be appreciated that such advantages, benefits, and/or solutions may be applicable to some example embodiments, but not necessarily all example embodiments. Thus, any advantages, benefits, and/or solutions described herein should not be construed as being critical, required, or essential to all embodiments or to that which is claimed herein. Although specific terms are employed herein, they are used in a generic and descriptive sense only and not for purposes of limitation.

What is claimed is:

1. A method for rapidly developing additive manufacturing materials, the method comprising:
a) disposing a powder layer into a powder pocket of a build device for an additive manufacturing (AM) machine;
b) executing a plurality of single-line trace patterns with the AM machine on a first portion of the powder layer to form a corresponding plurality of single-line traces on the build device; and
c) executing a plurality of sets of multiple-line trace patterns with the AM machine on a second portion of the powder layer to form a corresponding plurality of sets of multiple-line traces on the build device.

2. The method of claim 1, wherein the build device is a build disk.

3. The method of claim 1, wherein a total amount of powder in the powder layer is less than about 50 grams.

4. The method of claim 1, wherein a depth of the powder pocket within an upper surface of the build device is from about 20 micrometers to about 50 micrometers.

5. The method of claim 1, further comprising:
before step a), milling the powder pocket into the build device; and
after step a), securing the build device into at least one of a modified full build plate of the AM machine and a modified reduced build plate of the AM machine.

6. The method of claim 1, further comprising, after step a), smoothing a surface of the powder layer in the powder pocket.

7. The method of claim 1, further comprising, after step a), inputting one or more processing parameters into the AM machine, wherein the one or more processing parameters inputted into the AM machine comprise one or more of laser power, scan speed, scanning strategy, scanning angle, hatch spacing, hatch distance, and layer thickness.

8. The method of claim 1, further comprising, after step c), analyzing single-line traces of the plurality of single-line traces and sets of multiple-line traces of the plurality of multiple-line traces, wherein the analyzing the single-line traces and the sets of multiple-line traces comprises performing one or more of visual inspection, microscopy, and cross-sectional microscopy.

9. The method of claim 1, wherein the AM machine is a laser-powder bed fusion (L-PBF) AM machine.

10. A method for rapidly developing additive manufacturing materials, the method consisting of:
a) disposing a powder layer into a powder pocket of a build device for an additive manufacturing (AM) machine;
b) executing a plurality of single-line trace patterns with the AM machine on a first portion of the powder layer to form a corresponding plurality of single-line traces on the build device; and
c) executing a plurality of sets of multiple-line trace patterns with the AM machine on a second portion of the powder layer to form a corresponding plurality of sets of multiple-line traces on the build device.

11. The method of claim 10, further consisting of, after step a):
smoothing a surface of the powder layer in the powder pocket; and
inputting one or more processing parameters into the AM machine.

12. The method of claim 11, further consisting of, after step c), analyzing single-line traces of the plurality of single-line traces and sets of multiple-line traces of the plurality of multiple-line traces, wherein the AM machine is a laser-powder bed fusion (L-PBF) AM machine.

13. The method of claim 10, wherein a total amount of powder in the powder layer is less than about 50 grams.

14. A build device for an additive manufacturing process, comprising:
a base; and
a powder pocket formed in an upper portion of the base to receive a single powder layer.

15. The build device of claim 14, wherein
a depth of the powder pocket is from about 20 micrometers to about 50 micrometers, and
the powder pocket is formed to contain a total amount of powder that is less than about 50 grams.

16. The build device of claim 14, wherein
the base is a disk having a circular shape, and
an outer circumference of the powder pocket is circular and less than an outer circumference of the disk.

17. A system for rapidly developing additive manufacturing materials, comprising:
a build device comprising:
a base; and
a powder pocket formed in an upper portion of the base to receive a single powder layer; and
a plate configured to receive the build device.

18. The system of claim 17, wherein
a depth of the powder pocket is from about 20 micrometers to about 50 micrometers, and
the powder pocket is formed to contain a total amount of powder that is less than 50 grams.

19. The system of claim 17, wherein
the build device is a build disk having a circular shape, and
an outer circumference of the powder pocket is circular and less than an outer circumference of the build disk.

20. The system of claim 17, wherein the plate is a modified build plate of a laser-powder bed fusion (L-PBF) additive manufacturing (AM) machine.
